(19) United States
(12) Patent Application Publication
(10) Pub. No.: US 2004/0004537 A1
(43) Pub. Date: Jan. 8, 2004

(54) Vehicle remote control system for multiple or single vehicle operation and associated methods

(76) Inventor: Kenneth E. Flick, Douglasville, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/188,440

(22) Filed: Jul. 2, 2002

(51) Int. Cl. H04Q 1/00; G05B 19/00

(52) U.S. Cl. 340/5.62; 340/5.64; 340/825.72

(57) ABSTRACT

A vehicle remote control system includes a multi-bank remote transmitter to be carried by a user and having selectable signal banks, such as for different vehicles. The vehicle remote control system also includes a controller at the vehicle that is switchable to a first mode for learning at least one signal bank from the remote transmitter based upon transmission therefrom to define a learned operable signal bank for thereafter controlling at least one corresponding vehicle function. The controller is also switchable to a second mode for deriving at least one other operable signal bank based upon the learned operable signal bank so that the controller is responsive to the remote transmitter without learning the other signal bank. Accordingly, in some embodiments the controller may be responsive to the multi-bank remote transmitter irrespective of the selected banks.

### FIELD OF THE INVENTION

The present invention relates to the field of remote control systems, and, more particularly, remote control systems having multi-bank remote transmitters.

### BACKGROUND OF THE INVENTION

Vehicle security systems are widely used to deter vehicle theft and perform various security-related vehicle functions. A typical vehicle security system includes a controller having a receiver connected thereto. The controller may perform security-related functions, such as locking/unlocking doors, or switching between armed and disarmed modes responsive to signals received from one or more remote transmitters. When in the armed mode, the controller may generate an alarm indication at the vehicle responsive to a vehicle security sensor indicating a vehicle security breach. The remote transmitters are typically carried by the owner of the vehicle.

Some vehicle security systems are adapted for multi-vehicle operation. For example, one vehicle security system by Omega Research and Development designated by model “Excalibur 1800 ATV” includes a multiple vehicle operation feature. More particularly, multiple vehicles may be operated using one transmitter. Controllers in each of the vehicles are responsive to only one learned signal bank in the transmitter. The transmitter may be thereafter switched between signal banks to operate multiple vehicles.

One problem that arises with this type of system, however, is that the user may accidentally switch the transmitter to transmit signals from a different transmitter bank. This problem is especially of interest when the multi-bank system is installed for single car use. The user may not even be aware that different banks are selectable. If the selected bank is accidentally switched, the controller for the vehicle driven by the user will no longer be responsive to the transmitted signals. Since the user does not realize that the transmitter has been switched to transmit signals from another signal bank, the user may presume that the vehicle security system is malfunctioning, when in fact, the vehicle security system is in proper working order.

### SUMMARY OF THE INVENTION

In view of the foregoing background, it is therefore an object of the present invention to provide a vehicle remote control system including a controller that is more conveniently used with a multi-bank remote transmitter.

This and other objects, features, and advantages of the present invention are provided by a vehicle remote control system comprising at least one multi-bank remote transmitter to be carried by a user and having selectable signal banks for different vehicles. The vehicle remote control system may also comprise a controller at the vehicle. The controller may be switchable to a first mode for learning a signal bank from the remote transmitter based upon transmission therefrom to define an operable signal bank. The operable signal bank may be used to thereafter control corresponding vehicle functions. The controller may also be switchable to a second mode for deriving another operable signal bank based upon the learned signal bank so that the controller is responsive to the multi-bank remote transmitter without learning the other signal bank.

The controller may derive all other signal banks as operable signal banks in the second mode so that the controller is responsive to all signal banks irrespective of the selected signal bank. The selectable signal banks may be two in number, for example.

The vehicle remote control system may further comprise an indicator connected to the controller. The controller may cooperate with the indicator to generate an indication of a number of multi-bank remote transmitters learned into the controller. The controller and indicator advantageously alerts the user to learning of an unauthorized transmitter into the controller.

The corresponding vehicle functions may include vehicle door locking, vehicle engine starting, vehicle window operation, or vehicle trunk opening, for example.

The remote transmitter may include a housing, a plurality of switches carried by the housing for selecting the signal bank and vehicle functions, and a transmitter for transmitting signals of the selected signal bank based upon operation of the switches. The signal bank may be selectable by a predetermined operating sequence of at least one of the switches, for example.

The controller may further comprise a receiver, and a processor connected to the receiver. The controller may also be switchable to a feature programming mode permitting switching to the first or second modes.

A method aspect of the invention is directed to vehicle remote control. The method may include providing at least one multi-bank remote transmitter to be carried by a user and having selectable signal banks for different vehicles. The method may also include learning into a controller at the vehicle a signal bank from the remote transmitter based upon transmission therefrom to define an operable signal bank for thereafter controlling corresponding vehicle functions. The method may further include deriving another operable signal bank based upon the learned signal bank so that the controller is responsive to the remote transmitter irrespective of the selected signal bank and without learning the other signal bank.

### BRIEF DESCRIPTION OF THE DRAWINGS

FIG. 1 is a schematic block diagram of the vehicle remote control system according to the present invention.

FIG. 2 is a schematic block diagram of the remote transmitter shown in FIG. 1.

FIGS. 3-4 are flowcharts illustrating operation of the vehicle remote control system shown in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

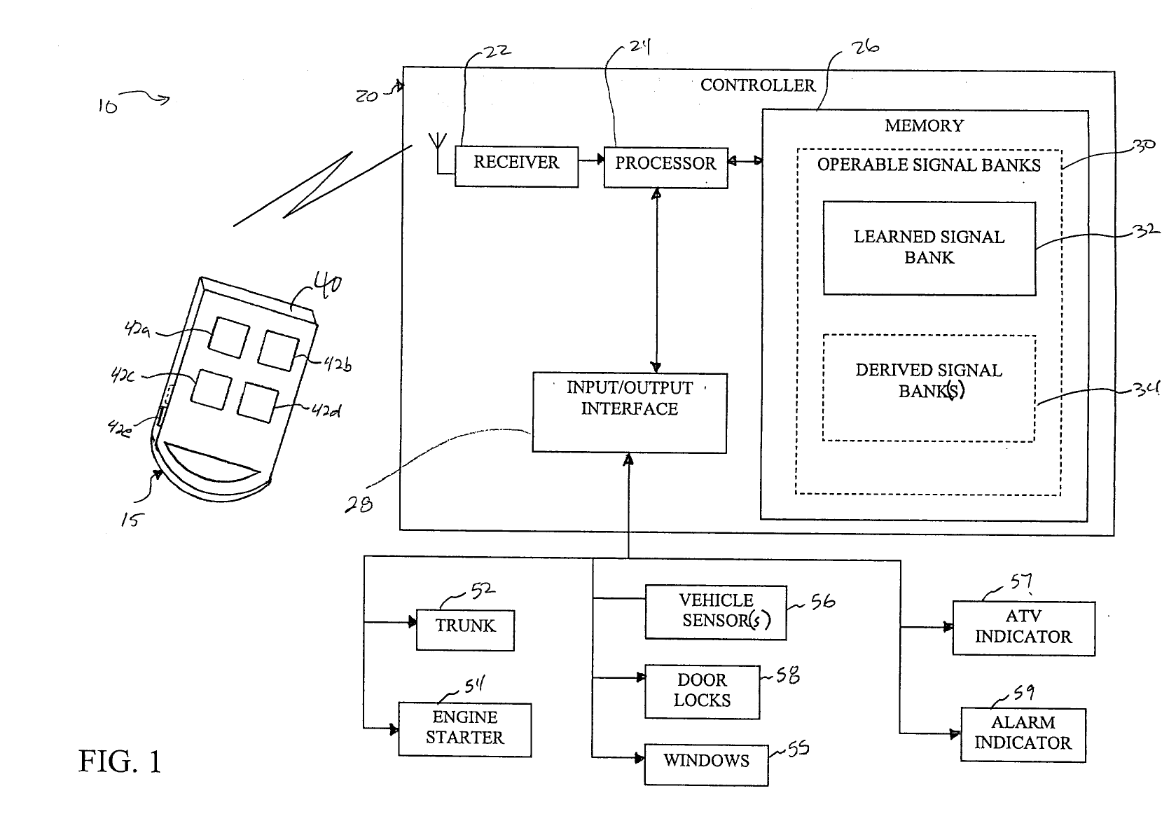

Referring initially to FIG. 1, a vehicle remote control system 10 is now described. The vehicle remote control system 10 illustratively includes at least one multi-bank remote transmitter 15 to be carried by a user. The multi-bank remote transmitter 15 includes selectable signal banks for different vehicles. The vehicle remote control system 10 also includes a controller 20 at the vehicle. The controller 20 includes a receiver 22 for receiving signals transmitted from the multi-bank remote transmitter 15. A processor 24 is connected to the receiver 22, and a memory 26 is connected to the processor. The memory 26 may store data for a plurality of operable signal banks 30.

The controller 20 is switchable to a feature programming mode to permit switching to first and second modes as described in greater detail below. More specifically, the controller 20 is switchable to a first mode for learning at least one signal bank from the remote transmitter 15 based upon transmission therefrom to define a learned signal bank 32 for thereafter controlling corresponding vehicle functions. Learning a signal bank, in some embodiments, may only require that a single code be received by the controller 20 to define the learned signal bank as will be appreciated by those skilled in the art. In other words, the controller 20 will learn a single code, and derive or be responsive to the other code(s) in the signal bank. In yet other embodiments, more than one code of a signal bank may be learned by the controller 20.

The controller 20 is also switchable to a second mode for deriving at least one other operable signal bank based upon the learned signal bank 32 to thereby define one or more derived signal banks 34. In the second mode, the controller 20 is responsive to the remote transmitter 15 without learning the other signal bank. The controller 20 may derive all other signal banks as operable signal banks 32 in the second mode so that the controller is responsive to all signal banks irrespective of the selected signal bank. In other words, derive is used to mean become responsive to, for example. For some systems 10 the coded bit stream from the multi-bank remote transmitter 15 may include a bit or set of bits which identify the selected bank. Deriving an operable signal bank 34 is used to mean recognizing and responding to the different bit or bits for the different selectable banks as will be appreciated by those skilled in the art.

The controller 20 further illustratively includes an input/output interface 28 connected to the processor 24 to interface the controller with vehicle devices. Typical vehicle devices that are interfaced with the controller 20 include a vehicle trunk release 52, an engine starter 54, vehicle windows 58, vehicle sensors 56, door locks 58, and an alarm indicator 59. Accordingly, the corresponding vehicle functions that may be controlled by the controller 20 include vehicle door locking, vehicle engine starting, vehicle window operation, and vehicle trunk operation. The controller 20 may also be switched between armed and disarmed states. When in the armed state, the controller may operate the alarm indicator 59 based on one of the vehicle sensors 56 as will be appreciated by those skilled in the art. Those skilled in the art will also appreciate that the controller 20 may be interfaced with many other vehicle devices and may accordingly control the vehicle functions corresponding to those vehicle devices.

The vehicle remote control system 10 also illustratively includes an automatic transmitter verification (ATV) indicator 57 that cooperates with the controller 20 to generate an indication of a number of multi-bank remote transmitters 15 that are learned into the controller. This advantageously enhances security of the vehicle remote control system 10 by indicating to a user whether the unauthorized transmitter 15 has been learned into the controller 20. The ability of the controller 20 to be switched to the second mode to derive and recognize other signal banks 34 also serves to provide accuracy of the ATV function, since all the banks of one remote transmitter show a count of only one transmitter. Of course, in the first mode the system 10 may be used so that the different signal banks can be selected by the user to operate different vehicles as will be appreciated by those skilled in the art.

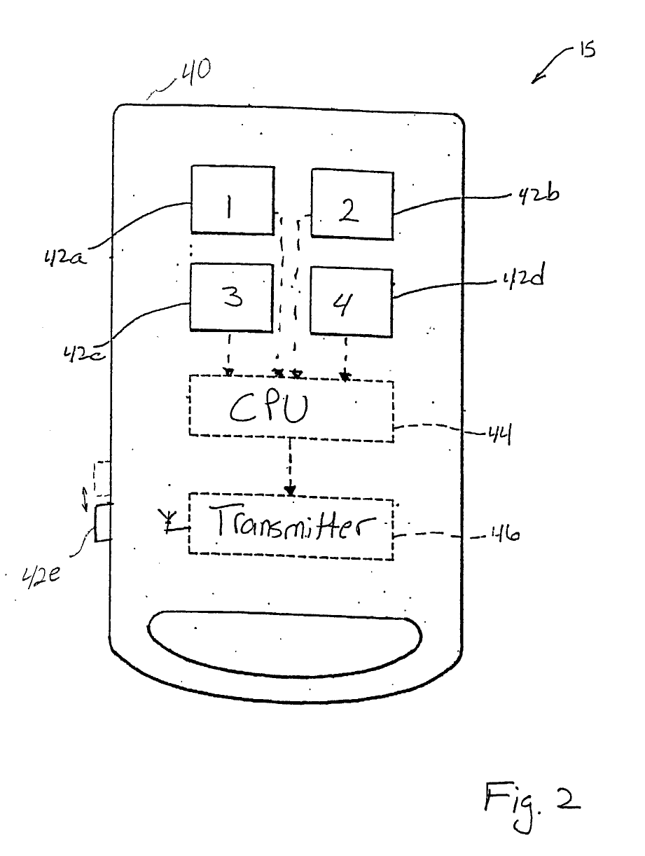

Turning now to FIG. 2, a multi-bank remote transmitter 15 of the vehicle remote control system 10 is now described. The remote transmitter 15 illustratively includes a housing 40, and a plurality of switches 42a-42e carried by the housing for selecting the signal bank and vehicle functions. The remote transmitter 15 also includes a central processing unit 44 and a transmitter 46 connected thereto for transmitting signals of the selected signal bank based upon operation of the switches. More specifically, the vehicle functions are controlled by the momentary contact switches 42a-42d positioned on a face of the transmitter 15. The signal banks are selectable by operation of the slide switch 42e illustratively positioned on a side of the remote transmitter 15. The slide switch 42e is slidable between positions corresponding to the signal banks. Alternately, the signal banks may be selectable by a predetermined operating sequence of one or more of the switches 42a-42d. For example, one of the plurality of switches 42a-42d may be operated a predetermined number of consecutive times within a predetermined time to switch the transmitter 15 to a selection mode, and, thereafter one of the signal banks may be selected by a predetermined number of operations of another switch 42a-42d within a predetermined time. Another predetermined operating sequence of the switches 42a-42d may exit the transmitter 15 from the selection mode, or the transmitter may exit the selection mode after a predetermined time.

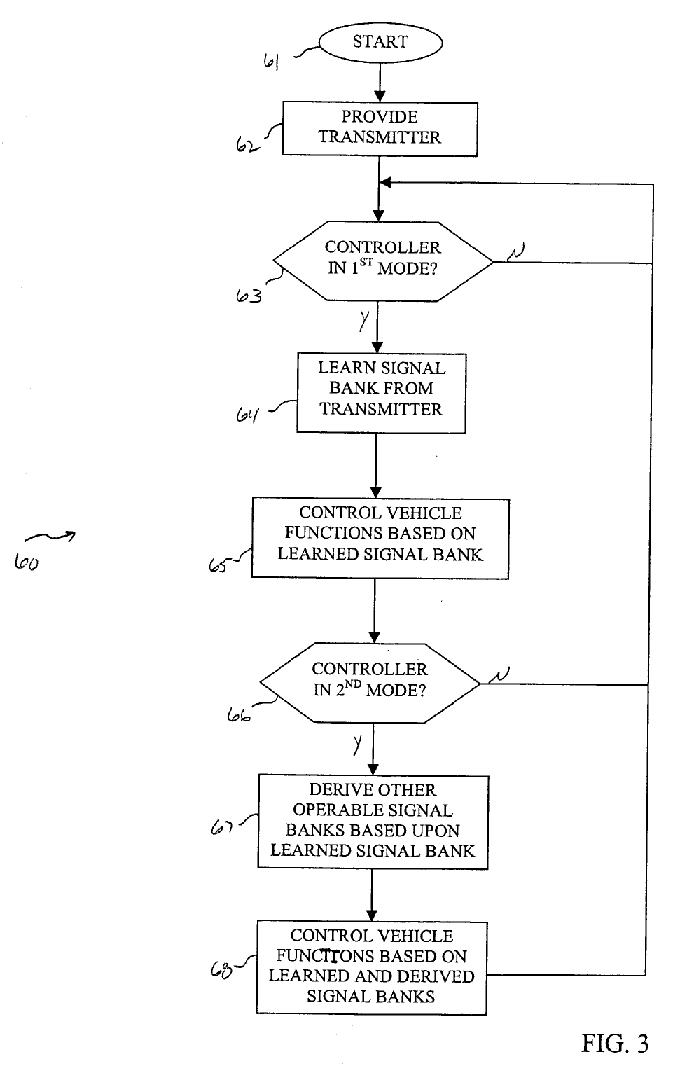

Turning now additionally to the flow chart 60 of FIG. 3, a vehicle remote control method aspect of the invention is now described. From the start (Block 61) a remote transmitter 15 is provided at Block 62. At Block 63 it is determined whether the controller 20 is in the first mode. If so, then at Block 64 a signal bank is learned from the transmitter 15. At Block 65, vehicle functions are controlled based on the learned signal bank 32. At Block 66 it is determined if the controller 20 is in the second mode. If it is determined that the controller 20 is in the second mode, then at Block 67 other operable signal banks are derived based upon the learned signal bank 32. At Block 68, vehicle functions are controlled based on the learned signal bank 32 and the derived signal bank 34.

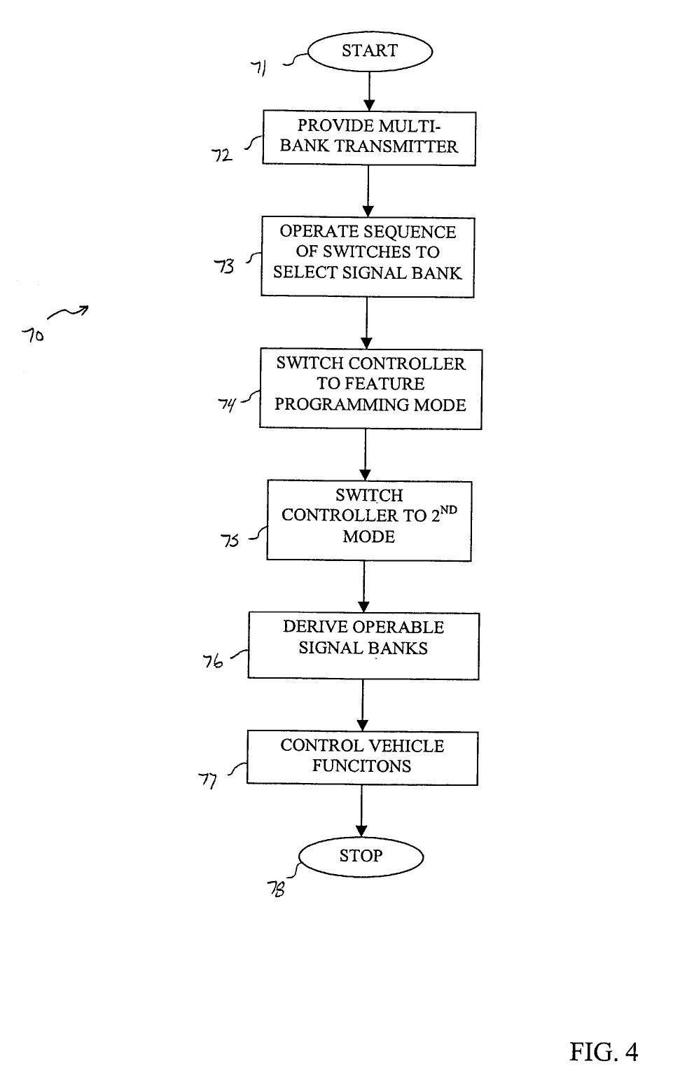

Turning now additionally to the flow chart 70 of FIG. 4, another vehicle remote control method aspect of the invention is now described. From the start (Block 71) a multi-bank remote transmitter 15 is provided at Block 72. At Block 73 a signal bank is selected by operating the at least one switches 42a-42e in a predetermined sequence. At Block 74 the controller 20 is switched to a feature programming mode to permit switching between first and second modes. At Block 75, the controller 20 is switched to the second mode. At Block 76, operable signal banks 30 are derived. At Block 77, vehicle functions are controlled based on the derived operable signal banks 34. The method is ended at Block 78.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A vehicle remote control system comprising:
at least one multi-bank remote transmitter to be carried by a user and having a plurality of selectable signal banks; and
a controller at the vehicle and being switchable to a first mode for learning at least one signal bank from said at least one multi-bank remote transmitter based upon transmission therefrom to define at least one learned operable signal bank for thereafter controlling at least one corresponding vehicle function;
said controller also switchable to a second mode for deriving at least one other operable signal bank based upon the at least one learned operable signal bank so that said controller is responsive to the at least one multi-bank remote transmitter without learning the at least one other signal bank.

2. A vehicle remote control system according to claim 1 wherein said controller derives all other signal banks as operable signal banks in the second mode so that said controller is responsive to all signal banks irrespective of the selected signal bank.

3. A vehicle remote control system according to claim 1 wherein the selectable signal banks are two in number.

4. A vehicle remote control system according to claim 1 further comprising an indicator cooperating with said controller to generate an indication of a number of multi-bank remote transmitters learned into said controller.

5. A vehicle remote control system according to claim 1 wherein the at least one corresponding vehicle function includes vehicle door locking.

6. A vehicle remote control system according to claim 1 wherein the at least one corresponding vehicle function includes vehicle engine starting.

7. A vehicle remote control system according to claim 1 wherein the at least one corresponding vehicle function includes vehicle window operation.

8. A vehicle remote control system according to claim 1 wherein the at least one corresponding vehicle function includes vehicle trunk opening.

9. A vehicle remote control system according to claim 1 wherein said at least one remote transmitter comprises:
a housing;
a plurality of switches carried by the housing for selecting the at least one signal bank and performing at least one vehicle function; and
a transmitter for transmitting signals of the selected signal bank based upon operation of said switches.

10. A vehicle remote control system according to claim 9 wherein at least one of said switches is operable in a predetermined pattern to select the signal bank.

11. A vehicle remote control system according to claim 1 wherein said controller comprises a receiver, and a processor connected to said receiver.

12. A vehicle remote control system according to claim 1 wherein said controller is switchable to a feature programming mode permitting switching to the first or second mode.

13. A vehicle remote control system comprising:
at least one multi-bank remote transmitter to be carried by a user and having selectable first and second signal banks, said at least one multi-bank remote transmitter comprising
a housing,
a plurality of switches carried by said housing for selecting of the first and second signal banks and performing at least one vehicle function, and
a transmitter for transmitting signals of the selected signal bank based upon operation of said switches; and
a controller at the vehicle and being switchable to a first mode for learning the first signal bank from said at least one multi-bank remote transmitter based upon transmission therefrom to define a first operable signal bank for thereafter controlling at least one corresponding vehicle function;
said controller also switchable to a second mode for deriving the second operable signal bank based upon the learned first signal bank.

14. A vehicle remote control system according to claim 13 further comprising an indicator cooperating with said controller to generate an indication of a number of multi-bank remote transmitters learned into said controller.

15. A vehicle remote control system according to claim 13 wherein the at least one corresponding vehicle function includes vehicle door locking.

16. A vehicle remote control system according to claim 13 wherein the at least one corresponding vehicle function includes vehicle engine starting.

17. A vehicle remote control system according to claim 13 wherein the at least one corresponding vehicle function includes vehicle window operation.

18. A vehicle remote control system according to claim 13 wherein the at least one corresponding vehicle function includes vehicle trunk opening.

19. A vehicle remote control system according to claim 13 wherein said controller further comprises a receiver, and a processor connected to said receiver.

20. A vehicle remote control system according to claim 13 wherein said controller is switchable to a feature programming mode permitting switching to the first or second mode.

21. A vehicle remote control method comprising:
providing at least one multi-bank remote transmitter to be carried by a user and having selectable signal banks;
learning into a controller at the vehicle at least one signal bank from the at least one multi-bank remote transmitter based upon transmission therefrom to define at least one operable signal bank for thereafter controlling at least one corresponding vehicle function; and
deriving at least one other operable signal bank based upon the learned at least one signal bank.

22. A method according to claim 21 further comprising deriving all other signal banks as operable signal banks so that the controller is responsive to all signal banks irrespective of the selected signal banks.

23. A method according to claim 21 further comprising generating an indication of a number of multi-bank remote transmitters learned into the controller.

24. A method according to claim 21 wherein the at least one corresponding vehicle function includes vehicle door locking.

25. A method according to claim 21 wherein the at least one corresponding vehicle function includes vehicle engine starting.

26. A method according to claim 21 wherein the at least one corresponding vehicle function includes vehicle window operation.

27. A method according to claim 21 wherein the at least one corresponding vehicle function includes vehicle trunk opening.

28. A method according to claim 21 wherein the at least one remote transmitter comprises:
a housing;
a plurality of switches carried by the housing for selecting the at least one signal bank and performing at least one vehicle function; and
a transmitter for transmitting signals of the selected signal bank based upon operation of the switches.

29. A method according to claim 28 further comprising selecting the signal bank by a predetermined operating sequence of at least one of the switches.
